(19) United States
(12) Patent Application Publication
(10) Pub. No.: US 2007/0020411 A1
(43) Pub. Date: Jan. 25, 2007

(54) Extended life polyimide toner transfer belts

(75) Inventors: Kathryn Dowlen Mullins, Lexington, KY (US); Peter Brown Pickett, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/183,535

(22) Filed: Jul. 18, 2005

(51) Int. Cl. B41M 5/00; B32B 27/00; B41M 5/40

(52) U.S. Cl. 428/32.51; 399/302; 428/32.12; 428/192; 428/473.5

(57) ABSTRACT

Examination of the side edges of available polyimide show that they are cut or formed on the angle that forms tapered extensions. This invention minimizes such tapered extensions. In the embodiment the side edges are made to be generally perpendicular to the top and bottom surfaces. The perpendicular sides eliminate thin extensions from which cracks can originate.

### TECHNICAL FIELD

This invention related to imaging with electrophotographic toner using a transfer belt of polyimide, which is particularly useful for three-color imaging.

### BACKGROUND OF THE INVENTION

Polyimide as the intermediate transfer layer material is known to provide excellent results in terms of image quality. Other materials commonly used as.transfer belts, such as polyurethanes, have long physical endurance. In contrast commercially available polyimide belts crack and become useless much earlier.

In view of the otherwise desirable factors in using polyimide belts as toner transfer belts, a solution to the early-failure problem is needed.

### DISCLOSURE OF THE INVENTION

Examination of the side edges of available polyimide belts shows that they are cut or formed on the angle, which forms tapered extensions. Since polyimide is very notch-sensitive, damage to the edge of the belt is more likely to occur at the weakest, thinnest regions. This invention minimizes such tapered extensions. In the embodiment the side edges are made to be generally perpendicular to the top and bottom surfaces. The perpendicular sides eliminate thin extensions which can be damaged in handling. Flex tests have shown polyimide belts with such sides to have the same physical life as other, conventional belts.

### BRIEF DESCRIPTION OF THE DRAWINGS

The details of this invention will be described in connection with the accompanying drawings, in which

FIG. 1 illustrates the electrophotographic printer (often termed a laser printer) in which the belt would be in accordance with this invention;

FIG. 2 is a cross section side view of a state of the art belt of polyimide as would be used unless modified in accordance with this invention; and

FIG. 3 is a cross section side view of a polyimide belt in accordance with this invention.

### DESCRIPTION OF THE PREFERRED EMBODIMENTS

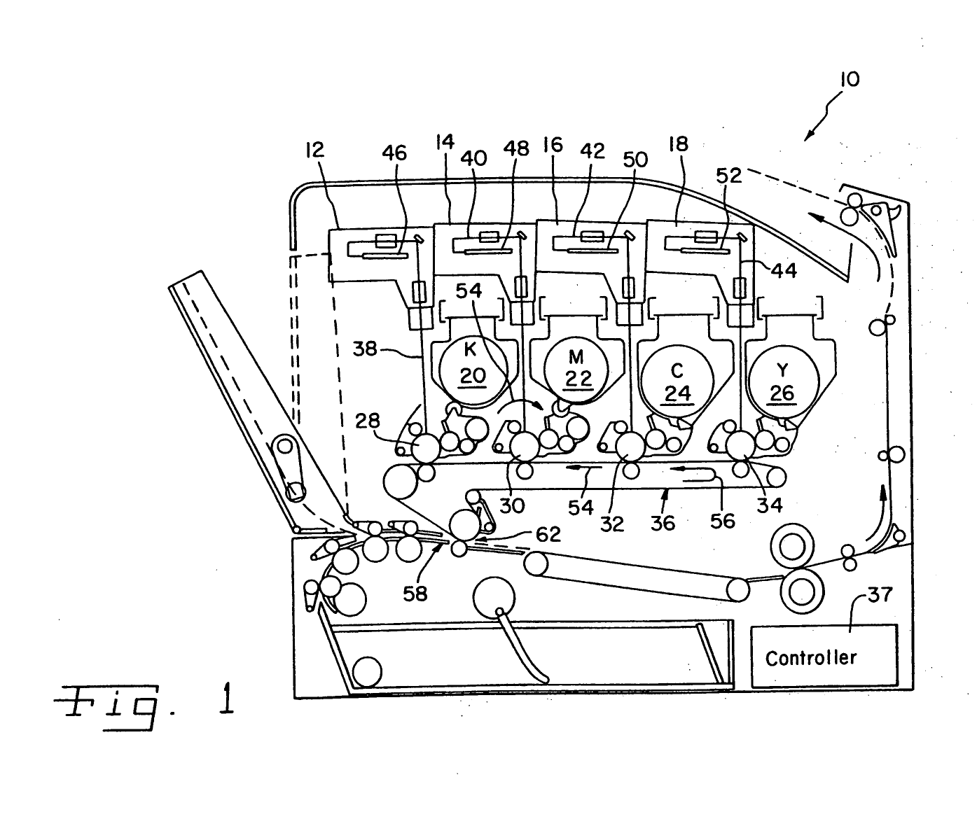

A description of the illustrative imaging device is found in commonly-owned U.S. Pat. No. 6,549,225 B2, and FIG. 1 is identical to FIG. 1 of that patent. In FIG. 1 there is shown a multicolor laser printer 10 in which the method of the present invention may be used. Printer 10 includes laser printheads 12, 14, 16, 18, a black toner cartridge 20, a magenta toner cartridge 22, a cyan toner cartridge 24, a yellow toner cartridge 26, photoconductive drums 28, 30, 32, 34, and intermediate transfer member belt 36 and a controller 37. The controller is a combination of Application Specific Integrated Circuits (ASIC's), microprocessors, and firmware suited to the tasks described.

Each of laser printheads 12, 14, 16, and 18 projects a respective laser beam 38, 40, 42, 44 off of a respective one of polygon mirrors 46, 48, 50 and 52. As each of polygon mirrors 46, 48, 50 and 52 rotates, it scans a respective one of reflected laser beams 38, 40, 42, and 44 in a scan direction, perpendicular to the plane of FIG. 1, across a respective on of photoconductive drums 28, 30, 32 and 34. Each of photoconductive drums 28, 30, 32 and 34 is negatively charged to approximately −1000 volts and is subsequently discharged to a level of approximately −300 volts in the areas of its peripheral surface that are impinged by a respective one of laser beams 38, 40, 42 and 44. During each scan of a laser beam across a photoconductive drum, each of photoconductive drums 28, 30, 32 and 34 is continuously rotated, clockwise in the embodiment shown, in a process direction indicated by direction arrow 54. The scanning of laser beams 38, 40, 42 and 44 across the peripheral surfaces of the photoconductive drums is cyclically repeated, thereby discharging the areas of the peripheral surface on which the laser beams impinge.

The toner in each of toner cartridge 20, 22, 24 and 26 is negatively charge and is transported upon the surface of a developer roll biased to approximately −600 volts. Thus, when the toner from cartridge 20, 22, 24 and 26 is brought into contact with a respective one of photoconductive drums 28, 30, 32 and 34, the toner is attracted to and adheres to the portions of the peripheral surfaces of the drums that have been discharged to −300 volts by the laser beams. As belts 36 rotates in the direction indicated by arrow 56, the toner from each of drums 28, 30, 32 and 34 is transferred to the outside surface of belt 36. As a print medium, such as paper, travels along path 58, the toner is transferred to the surface of print medium in nip 62.

It is belts corresponding to belt 36 that are structured in accordance with this invention. One structural aspect in accordance with this invention is that the material of the belt be polyimide or essentially polyimide. The reason for that aspect is that polyimide exhibits outstanding characteristics in receiving and transferring image that are of excellent fidelity to the images received from the photoconductors, such as drums 28, 30, 32 and 34.

By essentially polyimide or essentially of polyimide, it is meant that the polyimide can be diluted somewhat with other materials so long as it retains the outstanding characteristics of the entirely-polyimide belt in receiving and transferring images. Also, of course, a backing layer for support would not interfere with the characteristics of a belt, which is polyimide or essentially polyimide on the image-receiving side of the belt.

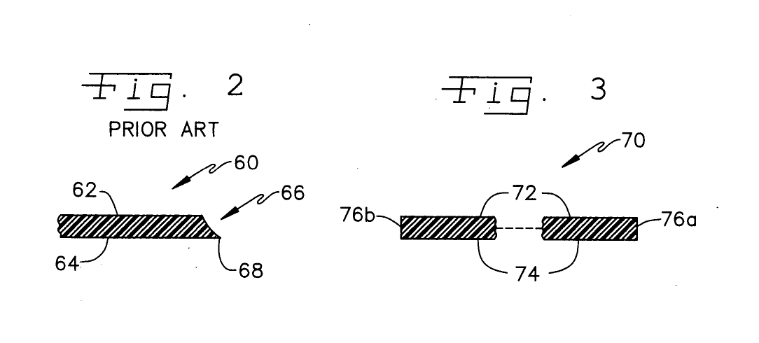

A second aspect in accordance with this invention is that the side edges not have tapered extensions. FIG. 2 illustrates a polyimide belt 60 currently available commercially. It has opposed lateral surfaces 62 and 64 terminated in a side edge 66. That side edge has a tapered extension 68. To prevent early cracking of the belt 60 resulting from damaged thin areas, such tapered extensions are avoided.

FIG. 3 illustrates a belt 70 in accordance with this invention. Belt 70 is made of all polyimide or is made essentially of polyimide. Belt 70 has a lateral surface 72 that is the image-receiving side and a lateral bottom surface 74. Although generally not required, bottom surface 74 may be formed of materials for support purposes, which are different from polyimide.

Surfaces 72 and 74 are sufficiently wide to receive the toner image. Belt 70 also has side edges 76a and 76b on opposed sides that constitute the thin dimension of the belt 70. In accordance with this invention side edges are substantially perpendicular to the lateral surfaces 72 and 74. This configuration is readily obtained by cutting commercial belts at the perpendicular angle with a blade having a flat face facing the belt.

Available polyimide belts in accordance with FIG. 2 survive a flex test to about 49 to 66 thousand cycles. State of the art belts not of polyimide survive the same test to 1,000,000 cycles. Belts in accordance with this invention, as illustrated in FIG. 3 also survive the same test to about 1,000,000 cycles.

The occasional tapered extension in a belt would necessarily not expose the belt to failure to the same extent as the belt having extensive tapered regions. Accordingly, belts that are substantially in accordance with the avoidance of tapered extensions are consistent with this invention.

Variations for the foregoing may be developed to avoid tapered extensions from the polyimide.

What is claimed is:

1. An electrophotographic imaging device printing by transferring to a transfer belt toner in at least two colors other than black characterized by said belt having a lateral, image-receiving surface comprising polyimide or essentially polyimide and having side edges on each side of said image-receiving surface, said side edges having substantially no tapered extensions.

2. The imaging device of claim 1 in which said belt consists of only polyimide or essentially polyimide.

3. The imaging device of claim 1 in which said side edges are substantially entirely generally perpendicular to said image-receiving surface.

4. The imaging device of claim 1 in which said side edges have no tapered extensions.

5. The imaging device of claim 2 in which said side edges have no tapered extensions.

6. The imaging device of claim 3 in which said side edges have no tapered extensions.

7. The imaging device of claim 2 in which said side edges are substantially entirely generally perpendicular to said image-receiving surface.

8. The imaging device of claim 3 in which said side edges are entirely generally perpendicular to said image-receiving surface.

9. The imaging device of claim 7 in which said side edges are entirely generally perpendicular to said imaging-receiving surface.

10. The imaging device of claim 1 in which said belt comprises polyimide.

11. The imaging device of claim 2 in which said belt consists of only polyimide.

12. The imaging device of claim 3 in which said belt comprises polyimide.

13. The imaging device of claim 4 in which said belt comprises polyimide.

14. The imaging device of claim 5 in which said belt consists of only polyimide.

15. The imaging device of claim 6 in which said belt comprises polyimide.

16. The imaging device of claim 7 in which said belt consists of only polyimide.

17. The imaging device of claim 8 in which said belt comprises polyimide.

18. The imaging device of claim 9 in which said belt consists of only polyimide.
